(19) United States
(12) Patent Application Publication
(10) Pub. No.: US 2023/0244246 A1
(43) Pub. Date: Aug. 3, 2023

(54) SYSTEMS, METHODS, AND COMPUTER-PROGRAM PRODUCTS FOR COLLABORATIVE PATH PLANNING OF MOBILE MACHINES IN UNSTRUCTURED AREA

(71) Applicant: Caterpillar Inc., Peoria, IL (US)

(72) Inventor: Craig L. KOEHRSEN, E Peoria, IL (US)

(73) Assignee: Caterpillar Inc., Peoria, IL (US)

(21) Appl. No.: 17/588,359

(22) Filed: Jan. 31, 2022

(51) Int. Cl. G05D 1/02; G08G 1/0968

(52) U.S. Cl. CPC G05D 1/0297; G08G 1/096811; G05D 2201/0202

(57) ABSTRACT

Systems and methods can implement collaborative path planning of mobile machines in an unstructured area. The systems and methods can involve receiving, at an area controller at a worksite, a list of mobile machines that are in the unstructured area, responsive to identification of the mobile machine entering (including just about to enter) the unstructured area from a structured area. The systems and methods can also involve receiving, at the area controller, location information including a location at which the mobile machine is to perform a task, when the mobile machine enters the unstructured area; and coordinating, via the area controller, with the mobile machines on the list of mobile machines, for the one mobile machine to traverse a locally determined path to the location at which the mobile machine is to perform the task without interfering with locally determined paths of the other mobile machines in the unstructured area.

### TECHNICAL FIELD

Embodiments of the disclosed subject matter relate to collaborative path planning of mobile machines, particularly collaborative planning of mobile machines in an unstructured area.

### BACKGROUND

Currently, a centralized method for path planning may be implemented in autonomous systems for the control of autonomous mobile machines. As autonomous systems are growing and mobile machines are getting smarter, each mobile machine may need to plan a path through structured areas as well as unstructured areas. Therefore, for efficient planning of undefined paths, particularly in unstructured areas, it may be desirable for the mobile machines to be aware of what other mobile machines are planning to do. This may be desirable where communication between the mobile machines and a centralized back office or the like for path planning is not possible or limited.

U.S. Patent Pub. No. 2019/0043355 (“the '355 patent publication”) describes a real-time violations and safety monitoring system on autonomous vehicles. The '355 patent publication describes that the platforms determine a real-time parking status for a plurality of parking locations, where the platform comprises a plurality of autonomous or semi-autonomous land vehicles each having one or more sensors configured to collect sensed data corresponding to a parking location; a communication device; and a processor. The processor is configured to provide an application comprising a parking spot recognition module that applies a parking assessment algorithm to determine the real-time parking status of the parking location based at least on the sensed data and that transmits the parking status to the database.

### SUMMARY

According to an aspect of the present disclosure, a method for collaborative path generation and control for a plurality of mobile machines at a worksite, where the worksite can have a predefined work area associated with an area controller for the predefined work area, is described or can be provided or implemented. The method can comprise: outputting, using circuitry of the area controller at the worksite, a list of mobile machines currently associated with the predefined work area directly to each of the mobile machines currently associated with the predefined work area based on identification of one of the mobile machines being newly associated with the predefined work area; outputting, using circuitry of the mobile machines currently associated with the predefined work area, directly to the circuitry of the mobile machine identified to be newly associated with the predefined work area, travel information for the mobile machines currently associated with the predefined work area, the travel information including at least determined travel paths in the predefined work area for the mobile machines currently associated with the predefined work area; and determining, using circuitry of the mobile machine identified to be newly associated with the predefined work area, a travel path through the predefined work area based on at least the travel information for the mobile machines currently associated with the predefined work area.

According to another aspect of the present disclosure, a system for collaborative path planning at a worksite having a structured area and a predefined unstructured area, where the structured area can have one or more predefined paths leading to/from the predefined unstructured area, and the predefined unstructured area can be free of any predefined paths, is described or can be implemented or provided. The system can comprise: a loading machine in the predefined unstructured area, the loading machine including communication circuitry and computer-readable memory; and a plurality of hauling machines to individually receive load material from the loading machine and haul the load material from the predefined unstructured area, the hauling machines including processing circuitry and communication circuitry to communicate with each other and with the loading machine. The loading machine can store in the computer-readable memory a real-time list of all of the hauling machines currently in the predefined unstructured area. The loading machine can transmit, using the communication circuitry, the real-time list of the hauling machines currently in the predefined unstructured area to one of the hauling machines entering the predefined unstructured area responsive to identification of said one hauling machine having entered the predefined unstructured area, without transmitting the real-time list to said one hauling machine via a back office system. The loading machine can transmit, using the communication circuitry, spot location information regarding a spot location in the predefined unstructured area for loading the load material to said one hauling machine responsive to identification of said one hauling machine having entered the predefined unstructured area, without transmitting the spot location information to said one hauling machine via the back office system. The one hauling machine can determine, using the processing circuitry, a path for traversing from a current position thereof upon entering the predefined unstructured area to the spot location to receive the load material from the loading machine and from the spot location to exit the predefined unstructured area, in coordination with determined paths of hauling machines of the plurality that are or will be in the predefined unstructured area at a same time as said one hauling machine, based on the real-time list and the spot location information from the loading machine and the determined paths from the hauling machines that are or will be in the predefined unstructured area at the same time as said one hauling machine.

According to another aspect of the disclosure, a non-transitory computer-readable storage medium having stored thereon instructions that, when executed by one or more processors, causes the one or more processors to perform a method is disclosed or can be provided or implemented. The method can comprise: receiving, at an area controller, a list of mobile machines that are in an unstructured area of a worksite, responsive to identification of a mobile machine entering the unstructured area from a structured area; receiving, at the area controller, location information including a location at which said mobile machine is to perform a task, when said mobile machine enters the unstructured area; and coordinating, via the area controller, the mobile machines on the list of mobile machines, for said one mobile machine to traverse a locally determined path to the location at which said mobile machine is to perform the task without interfering with locally determined paths of the other mobile machines in the unstructured area.

### BRIEF DESCRIPTION OF DRAWINGS

FIG. 1 is a representative illustration of a worksite according to one or more embodiments of the disclosed subject matter.

FIG. 2 is a block diagram of some machines at the worksite of FIG. 1 according to one or more embodiments of the disclosed subject matter.

FIG. 3 is shows exemplary operation according to one or more embodiments of the disclosed subject matter.

FIG. 4 is a flow chart of a method according to one or more embodiments of the disclosed subject matter.

### DETAILED DESCRIPTION

Embodiments of the disclosed subject matter relate to collaborative path planning of mobile machines, particularly collaborative planning of mobile machines in an unstructured area. Generally, the collaborative path planning can occur directly between the mobile machines and without direction from a back office system.

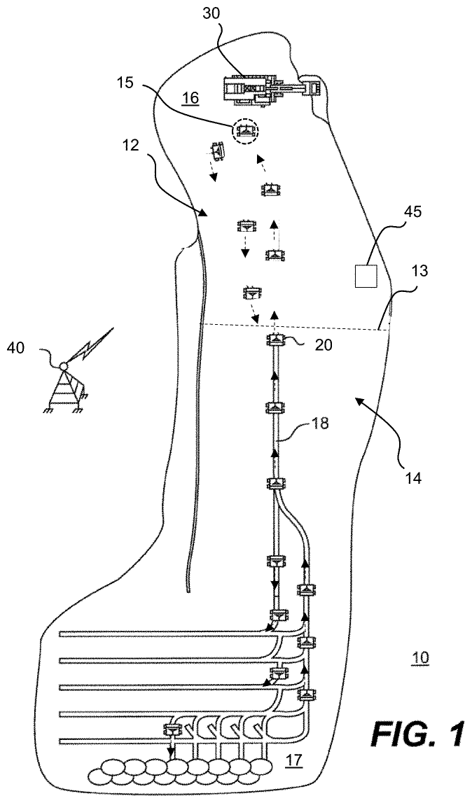

FIG. 1 illustrates an exemplary worksite 10 according to one or more embodiments of the disclosed subject matter. In one embodiment, the worksite 10 may embody a surface mine site. Alternatively, the worksite 10 may embody a construction site, a landfill, a quarry, an underground mine site, or any other worksite or jobsite.

A plurality of machines 20 and at least one machine 30 can be provided at the worksite 10. A back office system 40 may optionally be provided relative to the worksite 10. The back office system 40 may be in selective communication with the machine 30 and/or some or all of the machines 20. Discussed in more detail below, the machines 20 may, according to one or more embodiments, traverse the worksite 10 without input (at least real-time input) from the back office system 40.

The machines 20 may be or include autonomous (e.g., unmanned) machines or semi-autonomous machines. Generally, an “autonomous” machine can refer to an unmanned machine that includes on-board and/or off-board computers, processors, and/or other electronic controllers which, based on input from various machine sensors, stored data, and control algorithms, can provide outputs to control various machine systems such as steering, braking, and propulsion to accomplish desired tasks. Semi-autonomous machines may provide some functions that are controlled by the on-board and off-board systems, while allowing an operator to control other functions. Optionally, some or all of the machines 20 can be battery electric machines. Here, battery electric machines can mean or be defined as all-electric machines (e.g., battery electric vehicles (BEVs)) that use a battery or batteries exclusively to power the machine during travel or partially electric machines (e.g., hybrid electric vehicles (PHEVs or HEVs)) that use a battery or batteries at least part of the time to power the machine during travel.

The machines 20 employed at the worksite 10 may be of the same type or different types. For example, the machines 20 may include digging machines, loading machines, hauling machines, transport machines, multi-functional machines (e.g., wheel tractor scrapers), and other types of machines. Thus, a variety of machines may be operated over the worksite 10 at various locations. In FIG. 1 the machines 20 are represented as haul or hauling machines (e.g., haul trucks, dump trucks, etc.), though embodiments of the disclosed subject matter are not so limited. The machine 30 can be a loader (e.g., a wheel loader, an excavator, etc.).

The worksite 10 can have an unstructured area 12 and a structured area 14. The structured area 14 can have one or more predefined paths 18, some or all of which can lead to/from the unstructured area 12, whereas the unstructured area 12 may not have any or otherwise be free of any predefined paths 18. The unstructured area 12, at least boundary portions where entrance and/or exit may occur to/from the structured area 14, can be electronically defined by a boundary 13, for instance, by beacons, a geofence, etc. Thus, the unstructured area 12 may be referred to or characterized as a predefined unstructured area 12.

The worksite 10 can have one or more predefined work areas. For instance, FIG. 1 shows a first work area 16 that can be designated as a load area for the worksite 10. The worksite 10 may also include one or more other predefined work areas, such as a second work area 17 that can be designated as a dump area for the worksite 10. Thus, as noted above, the machines 20 can be haul machines 20 and the machine 30 can be a loading machine 30 to load material (e.g., earth) into the hauling machines 20 when in the load area 16. In that the machines 20 can travel to and from the load area 16 and the dump area 17 (and the unstructured area 12 and the structured area 14), the machines 20 can be referred to or characterized as mobile machines. A location where the machines 20 can be positioned to receive the load material from the loading machine 30 can be referred to or characterized as a spot location 15. As machines 20 operate at the worksite 10, the shapes, dimensions, and general positions of load are 16, dump are 17, and/or travel path(s) 18 may change. Thus, the spot location 15 can change depending upon where the loading machine 30 is digging in the load area 16. The spot location 15 can be set (or reset) electronically by the loading machine 30, for instance. According to one or more embodiments, the spot location 15 can be identified by a geofence, a beacon, or the like.

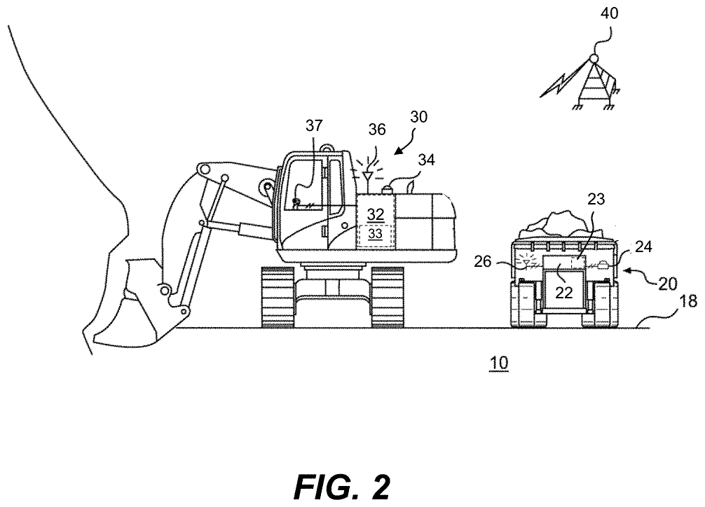

As shown in FIG. 2, the machine 30 may be equipped with a controller or control module 32 that can facilitate autonomous control of machine 30. The controller 32, which may be implemented in or using circuitry, may be operatively coupled to a locating device 34, and a communicating device 36. The controller 32 can include or otherwise be able to access memory 33. Memory 33, which may be referred to or characterized as computer-readable memory (non-transitory), can store a list of machines 20 in the unstructured area 12. Optionally, the memory 33 can store a list of the machines 20 in the structured area 14 or a list of all of the machines 20 at the worksite 10 and their respective positions within the worksite 10.

The controller 32 may be operatively coupled to one or more operator interface devices 37. Operator interface devices 37 may include, for example, an input device such as a joystick, keyboard, steering wheel, pedal, lever, button, switch, etc. Additionally or alternatively, operator interface devices 37 may include or be a display device such as a monitor with a graphical user interface (GUI).

Locating or positioning device 34, which may be implemented in or using circuitry, may be configured to determine a position of machine 30 and generate a signal indicative thereof. Locating device 34 can embody, for example, a Global Positioning System (GPS) device, an Inertial Reference Unit (IRU), a local tracking system, or any other known locating device that receives or determines positional information associated with machine 30. Optionally, in conjunction with work implement geometry and work implement positioning information of the machine 30, the controller 32 can determine or otherwise set the spot location 15 based on the position of the machine 30, as determined based on the locating device 34, and the work implement geometry and work implement positioning information.

Communicating device 36, which may be implemented in or using circuitry, may include hardware and/or software that enables communicating (sending and/or receiving) of data or information between the controller 32 and the machines 20. Data or information may also be communicated between the controller 32 and the back office system 40. Such communication between the controller 32 and the machines 20, via the communicating device 36, can be via one or more wireless networks. For example, one or more local wireless networks (e.g., LANs, WANs, etc.) at the worksite 10 may be used to communicate data between the controller 32 and the machines 20. The communication between the controller 32 and the back office system 40, via the communicating device 36, can be via one or more wireless networks, for instance, a cellular network, a satellite network, etc.

Also shown in FIG. 2, each of the machines 20 may be equipped with a controller or control module 22 that can facilitate autonomous control of machine 20. The controller 22, which may be implemented in or using circuitry, may be operatively coupled to a locating device 24, and a communicating device 26. The controller 22 can include one or more processors. Hence, the controller 22, or portions thereof, may be referred to or characterized as a processor or processing circuitry. The controller 22 can include or otherwise be able to access memory 23. Memory 23, which may be referred to or characterized as computer-readable memory (non-transitory), can store a list of machines 20 in the unstructured area 12. Optionally, the memory 23 can store a list of the machines 20 in the structured area 14 or a list of all of the machines 20 at the worksite 10 and their respective positions within the worksite 10. Data containing the list of machines 20 can be sent from the machine 30. The list of machines 20 may or may not include the machine 20 receiving the list, since such machine 20 can know that its position is within (e.g., has entered) the unstructured area 12.

Locating or positioning device 24, which may be implemented in or using circuitry, may be configured to determine a position of machine 20 and generate a signal indicative thereof. Locating device 24 can embody, for example, a Global Positioning System (GPS) device, an Inertial Reference Unit (IRU), a local tracking system, or any other known locating device that receives or determines positional information associated with machine 20.

Communicating device 26 (which can be or include multiple communication devices), which may be implemented in or using circuitry, may include hardware and/or software that enables communicating (sending and/or receiving) of data or information between the controller 22 and some or all of the other machines 20, particularly at least or only those within the unstructured area 12. Data or information may also be communicated between the controller 22 and the machine 30, for instance, the controller 32 thereof. Such communication between the controller 22 and the other machines 20, via the communicating device 26, can be via one or more wireless networks. For example, one or more local wireless networks (e.g., LANs, WANs, etc.) at the worksite 10 may be used to communicate data between the machines 20. The communication between the controller 22 and the machine 30, via the communicating device 26, can be via one or more local wireless networks (e.g., LANs, WANs, etc.) at the worksite 10. Optionally, some or all of the machines 20 may communicate with the back office system 40, for instance, via a wireless network in the form of a cellular network, a satellite network, etc.

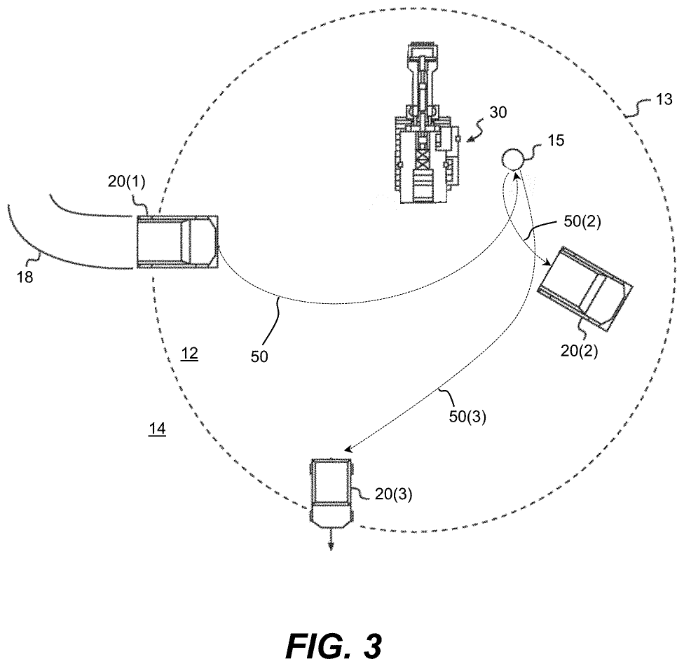

Turning now to FIG. 3, FIG. 3 shows exemplary operations according to systems and components thereof (e.g., machine 30 and/or machines 20) according to one or more embodiments of the disclosed subject matter. Here, the unstructured area 12 is defined inside the unstructured area boundary 13 identified by the broken-line circle. One machine 30 and three machines 20(1) 20(3) are provided relative to the unstructured area boundary 13.

The machine 30 can have a list of machines 20 in the unstructured area 12, for instance, stored in the memory 23. Generally, when one of the machines 20 enters the unstructured area 12 and when one of the machines 20 leaves the unstructured area 12 the list of machines in the unstructured area 12 can be updated. In this regard, the list may be kept up-to-date and, therefore, may be referred to or characterized as a real-time list. Put more generally, the list of machines 20 can be provided to machines 20 that have been associated with (e.g., assigned to) the worksite 10, the unstructured area 14, or some other area of the worksite 10 (e.g., load area 16 and/or dump area 17).

According to one or more embodiments, one of the machines 20 can be identified to have undergone a transition to/from the unstructured area 12 based on corresponding entry/exit signaling received by the machine 30 from the transitioning machine 20. Such signaling, which may be referred to or characterized as entry/exit indication signaling, may be transmitted immediately upon the machine 20 transitioning to/from the unstructured area 12. According to one or more embodiments, such signaling may be output by the transitioning machine 20 based on the machine 20 previously knowing the boundary of the unstructured area 12 from boundary data received from the machine 30 and the position of the machine 20 using, for instance, the locating device 24. Additionally or alternatively, the transition signaling may be output from the transitioning machine 20 when the machine 20 identifies that it is now within a predetermined distance away from a predetermined or predefined work area (e.g., load area 16) or portion thereof, such as the unstructured area 12 or the spot location 15, based on the machine 20 knowing its position relative to the particular portion of the unstructured area 12. Alternatively, the machines 20 may transmit (e.g., continuously or periodically) their positions, i.e., proximity signaling, to the machine 30 and the controller 32 of the machine 30 can identify whether the machine 30 is still in the unstructured area 12 or has exited or entered the unstructured area 12. Such signaling may be transmitted by the communicating device 26 of the machine 20 and received by the communicating device 36 of the machine 30, for instance, under control of the controller 22 and the controller 32 of the machine(s) 20 and the machine 30, respectively. Additionally, such signaling may be directly between the machine(s) 20 and the machine 30 without going through the back office system 40.

In response to the identification of one of the machines 20 entering the unstructured area 12 and/or in response to the identification of one of the machines 20 leaving the unstructured area, the machine 30 can output, via the communicating device 36, the updated list to all of the machines 20 currently known to be in the unstructured area 12. In the case of one of the machines 20 newly entering the unstructured area 12, for instance, as part of a new haul cycle (from the load area 16 to the dump area 17), the list may be considered or characterized as a new list and may include all of the machines 20 currently in the unstructured area 12, optionally without including the machine 20 newly entering the unstructured area 12 (e.g., since such machine 20 can know that its position is within (e.g., has entered) the unstructured area 12). In the case of the machines 20 already in the unstructured area 12, the list can be considered or characterized as an updated list since the machine 20 newly entering can have been added to the list prior to the machine 30 outputting the list to these machines 20. Sending the list to the machines 20 in the unstructured area 12 can be without sending the list to or through the back office system 40. The machines 20 may store the list in respective memories 23. Thus, the entering machine 20 can know what other machines 20 are in the area and what other machines 20 to communicate with for travel path planning.

The machine 30 can also output via the communicating device 36, to the machines 20, location information regarding specific portions of the worksite 10, for instance, where the machine 20 is to perform a task. As an example, the location information can be or include location information or data identifying the spot location 15. Such location information can be sent directly to the machines 20 without going to or through the back office system 40. The location information can be sent to one of the machines 20 being identified as having entered the unstructured area 12, as discussed above, for instance. At some point the machine 30 may need to change the location of the spot location 15. The machine 30 can send updated location information for the changed spot location 15 to some or all of the machines 20 currently in the unstructured area 12 (including a machine 20 newly entering the unstructured area 12). According to one or more embodiments, the updated location information for the spot location 15 can be sent only to the machines 20 in the unstructured area 12 that have yet to be loaded at the spot location 15 and not to any machines 20 in the unstructured area 12 that have already been loaded at the spot location 15.

The machine 20 newly entering the unstructured area 12 can coordinate with some or all of the other machines 20 in the unstructured area 12 so as to travel from the entry point of the unstructured area 12 to the spot location 15 (to receive the loading material) and from the spot location 15 to an exit point of the unstructured area 12 (which may be the same as the entry point, without obstructing movement (e.g., colliding with, slowing down, and/or rerouting, etc.) of any of the other machines 20 in the unstructured area 12. Such coordination can be in response to the machine 20 having been identified as entering the unstructured area 12. The controller 22 of the machine 20 can perform some or all of the coordinating operations per machine 20.

Referring again specifically to FIG. 3, the machine 20(1) can coordinate path planning with the other machines 20(2) and 20(3) in the unstructured area 12 based on the list of machines 20 received from the machine 30 upon the machine 20(1) having been identified to have entered the unstructured area 12. The machine 20(1) can also perform path planning using the location information for the spot location 15 from the machine 30.

The controller 22 of the machine 20(1) can determine, using a path planning algorithm, for instance, a travel path 50 for the machine 20(1) to travel from the entry point of the unstructured area 12 to the spot location 15 (to receive the loading material) and from the spot location 15 to an exit point of the unstructured area 12 (which may be the same as the entry point. As noted above, such travel can be without obstructing movement of the machines 20(2) and 20(3). Such travel can also be such that the machine 20(1) can avoid particular movement of the machine 30, for instance, movement of the work implement about some portion of the swing circumference of the work implement. Thus, determined travel path 50 can have a speed component and a timing component. The travel path 50, therefore, may cross travel paths of the other machines 20(2), 20(3); however, the timing can be such that the machines 20 do not impede each other.

Here, the path planning to determine the travel path 50 for the machine 20(1) can include travel information of the machine 20(2) and/or the machine 20(3) transmitted from the machine 20(2) and/or the machine 20(3), respectively, to the machine 20(1). The travel information can be transmitted directly from the machine 20(2) and/or the machine 20(3) to the machine 20(1) without going through the machine 30 or the back office system 40. As noted above, however, the machine 30 may send to the machine 20 the list of machines in the unstructured area 12 and the location information regarding the spot location 15, both of which may be used for the path planning. In that the path planning can be performed by each machine 20 without input from the back office 40, the travel paths may be referred to or characterized as locally-determined travel paths. According to one or more embodiments, travel information can include state information regarding the machine 20(2) and/or 20(3), such as position, work status (unloaded, loaded, to-be-loaded, loading, dumping, in queue to be loaded, priority, etc.).

The travel information from the machine 20(2) and/or the machine 20(3) can include respective determined travel paths 50(2), 50(3) for the machine 20(2) and/or the machine 20(3), for instance, determined by the machine 20(2) and/or the machine 20(3), at least when each of the machine 20(2) and the machine 23(3) entered the unstructured area 12. Like the travel path 50, the travel paths 50(2), 50(3) can have a speed component and a timing component.

According to one or more embodiments, the controller 22 of the machine 20(1) can determine its travel path 50 (or portion(s) thereof) using travel information from machines 20 currently in the unstructured area 12, such as the machine 20(2) and the machine 20(3). According to one or more embodiments, the determination of the travel path 50 can be in terms of lanes, that is, setting a lane or lanes for the machine 20(1) to travel to and from the spot location 15 in light of lanes associated with the other machines 20, for instance, so the travel paths 50 do not conflict with each other.

According to one or more embodiments, the controller 22 of the machine 20(1) and/or controllers 22 for each of the machines 20, may be referred to or characterized as an area controller. Hence, the area controller can be onboard the machine 20(1) and/or some or all of the machines 20. Alternatively, the area controller 45 may be offboard the machines 20 (including machine 20(1)). For instance, the area controller 45 may include a processor, which may be implemented in or using circuitry, provided at the worksite 10, for instance, in the unstructured area 12.

Optionally, the determined travel path 50 can correspond to only travel from the entrance point of the unstructured area 12 to the spot location 15. The machine 20(1) may update the travel path 50 or otherwise determine another portion of the travel path 50 when ready to leave the spot location 15. Here, for the updated travel path 50 or the additional portion of the travel path 50, the controller 22 may use travel information from machines currently in the unstructured area 12, which may have changed since the machine 20(1) arrived at the spot location 15. Thus, the updated travel path 50 or the additional portion of the travel path 50 determined by the controller 22 can use only path information from machines 20 entering the unstructured area 12 after the machine 20(1) has entered the unstructured area 12 and before the machine 20(1) has exited the unstructured area 12. Put another way, the controller 22 can determine the travel path 50 (or a portion thereof) based on travel information from machines that are or will be in the unstructured area 12 at the same time as the machine 20(1). In this regard, the controller 22 can continuously or periodically determine the travel path 50 (or portion thereof) as the machine 20(1) travels through the unstructured area 12. Optionally, the controller 22 may determine the portion of the travel path 50 after the spot location 15 using only travel information from machines 20 having yet to reach the spot location 15, since in theory the previously leaving machines 20 should exit the unstructured area 12 before the machine 20(1) and therefore should not interfere with the machine 20(1) presently leaving the spot location 15.

Optionally, each of the machines 20 may have a map of the worksite 10 or portion thereof (e.g., unstructured area 12) saved in the memory 23. The map can include information such as obstacles, forbidden zones, etc. The controllers 22 of the machines 20 can access the map to generate travel paths 50.

The machine 20(1) can be controlled, for instance, via the controller 22, to move according to the determined travel path 50 (or travel path portions). This may include controlling the speed and/or timing (e.g., stops, delay at spot location 15, etc.) of the machine 20(1) such that the machine 20(1) does not interfere with any of the other machines 20 in the unstructured area 12, including those entering and/or leaving the unstructured area 12.

### INDUSTRIAL APPLICABILITY

Embodiments of the disclosed subject matter relate to collaborative path planning of mobile machines, particularly collaborative planning of mobile machines in an unstructured area. The collaborative path planning can occur directly between the mobile machines and without direction from a back office system.

Thus, embodiments of the present disclosure can relate to using a decentralized, local methodology and system for path planning. More particularly, the present disclosure pertains to methods and systems for sharing paths between machines that are present in an unstructured area. Each machine can implement its own deterministic method for knowing which other machines are present in the area. This can be determined by making the machine talk to a controller upon entering the area (i.e., just before entering or as entering) to ask which machines are present in the area or which machines are arriving. The controller can be either present on the machine (such as a loader) in the area or is an infrastructure device present in the area. Each machine can use a deterministic solution to share its path with other machines. This can include that the machine will know that all other machines in the area will receive its path.

One or more embodiments of the disclosed subject matter can involve a system and method for path planning for two or more mobile machines (e.g., vehicles, trucks, etc.) within a region that may include a minesite with a loading area wherein a spot is determined for loading by a loading machine (e.g., shovel) can be provided or implemented (where the spot typically can be set by the operator of the shovel). Each mobile machine can be provided with a map that may include defined areas of operation, and based on the spot point provided, each mobile machine can develop a path to the spot point in turn. Machine to machine communication can allow for collaborative path planning that involves selecting a route that minimizes machine delays and maximizes efficiency. System parameters can include priorities between loaded and unloaded mobile machines, machine locations, machine type, and payload size. Paths can be selected based on path planning algorithms to avoid intersections of paths, set timing, and speed of machine movements, which mobile machines may stop and at what locations. The mobile machines can collaborate within a certain zone, or within a certain distance of each other, within a distance from a loader or loading machine, for instance. In another embodiment a mobile machine for the collaboration may be included in collaboration if it is expected that the mobile machine will arrive to the zone of operation during a time when other machines are in the same zone of operation. Updates to path planning may occur periodically on a continuous basis or upon an event, such as an updated spot location or a new mobile machine entering the area, or an obstacle entering the area. According to one or more embodiments, the path planning can occur in distributed fashion locally at each of the mobile machines, via machine-to-machine (M2M) communication, such as described above. Each of the machines can, at least to some extent (fully or partially) be independent and calculate their own travel paths based on where each machine may need to go in light of calculated travel paths of other machines based on their own respective interests.

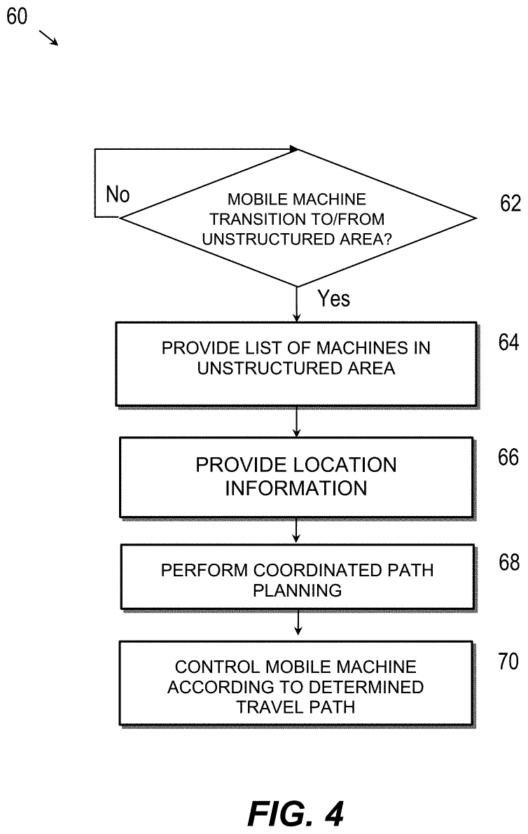

FIG. 4 is a flow chart of a method 60 according to embodiments of the disclosed subject matter. Some or all of the method 60 can be performed via a non-transitory computer-readable storage medium (or media) having stored thereon instructions that, when executed by one or more processors, such as the processor 22 of one of the machines 20 or the processors 22 of multiple ones of the machines 20, causes the one or more processors to perform some or all of the method 60. According to one or more embodiments, the method 60 may be referred to or characterized as a method for collaborative path planning, for instance, in an unstructured area. Additionally or alternatively, the method 60 may be referred to or characterized as a method for collaborative path generation and control for a plurality of mobile machines.

At 62 the method 60 can include determining whether a mobile machine transitioned relative to an unstructured area, such as unstructured area 12 shown in FIG. 1 or FIG. 3. According to one or more embodiments, the machine 30 may make this determination, using controller 32, for instance, based on transition signaling from the entering/leaving machine.

At 64 the method 60 can involve providing a list of all of the machines 20 currently in the unstructured area 12. The list can be sent from the machine 30 to all of the machines 20 currently in the unstructured area 12, including one of the machines 20 newly entering the unstructured area 12. Generally, the list can identify to the machines 20 in the unstructured area which other machines 20 to communicate with in order to perform coordinated path planning of the machines 20 in the unstructured area 12. The list may be provided from the machine 30 directly to the machines 20 in the unstructured area 12 without going through a back office system, such as back office system 40.

At 66 the method 60 can include providing location information. The location information can identify a particular portion or portions of the worksite 10, such as the spot location 15, for the machines 20 to perform a work task or otherwise travel to when in the unstructured area 12. According to one or more embodiments, the machine 30 can transmit location information regarding the spot location 15 to the machines 20, for instance, upon each machine 20 entering the unstructured area 12, directly without the location information going through the back office system 40. Optionally, providing the location information at 66 can be performed at the same time as or before outputting the list at 64.

At 68 the method 60 can include performing coordinated path planning between the machines 20 within the unstructured area 12. This can include the machines 20 already in the unstructured area 12 sending their travel information, which can include already-determined travel paths, to one of the machines 20 having newly entered the unstructured area 12. The travel information can be sent directly between the machines 20 without going through the back office system 40, and the machine 20 having newly entered the unstructured area 12 can determine its own travel path 50 to perform a task (e.g., loading operation) within the unstructured area 12 based on the travel information of the other machines 20 that are or will be in the unstructured area 12 at the same time as the machine 20 having newly entered the unstructured area 12.

At 70 the method 60 can include controlling the machine 20 having newly entered the unstructured area 12 according to its own determined travel path 50. Some or all of the machines that are or will be in the unstructured area 12 at the same time as the machine 20 may also be controlled according to their respective own determined travel paths. Depending upon whether the machines 20 entered the unstructured area 12 before or after the machine 20 having newly entered the unstructured area 12, some or all of the other machines 20 may determine their travel paths based on the travel path 50 determined by the machine 20 having newly entered the unstructured area 12. For instance, each machine 20 entering the unstructured area 12 after the machine 20 having newly entered the unstructured area 12 may determine their respective travel paths based on the determined travel path 50 of the machine 20 having newly entered the unstructured area 12.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

While aspects of the present disclosure have been particularly shown and described with reference to the embodiments above, it will be understood by those skilled in the art that various additional embodiments may be contemplated by the modification of the disclosed machines, assemblies, systems, and methods without departing from the spirit and scope of what is disclosed. Such embodiments should be understood to fall within the scope of the present disclosure as determined based upon the claims and any equivalents thereof.

1. A system for collaborative path planning at a worksite having a structured area and a predefined unstructured area, the structured area having one or more predefined paths leading to/from the predefined unstructured area, and the predefined unstructured area being free of any predefined paths, the system comprising:
a loading machine in the predefined unstructured area, the loading machine including communication circuitry and computer-readable memory; and
a plurality of hauling machines to individually receive load material from the loading machine and haul the load material from the predefined unstructured area, the hauling machines including processing circuitry and communication circuitry to communicate with each other and with the loading machine,
wherein the loading machine stores in the computer-readable memory a real-time list of all of the hauling machines currently in the predefined unstructured area,
wherein the loading machine transmits, using the communication circuitry, the real-time list of the hauling machines currently in the predefined unstructured area to one of the hauling machines entering the predefined unstructured area responsive to identification of said one hauling machine having entered the predefined unstructured area, without transmitting the real-time list to said one hauling machine via a back office system,
wherein the loading machine transmits, using the communication circuitry, spot location information regarding a spot location in the predefined unstructured area for loading the load material to said one hauling machine responsive to identification of said one hauling machine having entered the predefined unstructured area, without transmitting the spot location information to said one hauling machine via the back office system, and
wherein said one hauling machine determines, using the processing circuitry, a path for traversing from a current position thereof upon entering the predefined unstructured area to the spot location to receive the load material from the loading machine and from the spot location to exit the predefined unstructured area, in coordination with determined paths of hauling machines of the plurality that are or will be in the predefined unstructured area at a same time as said one hauling machine, based on the real-time list and the spot location information from the loading machine and the determined paths from the hauling machines that are or will be in the predefined unstructured area at the same time as said one hauling machine.

2. The system according to claim 1, wherein said one hauling machine continuously determines the path as said one hauling machine and the hauling machines that are or will be in the predefined unstructured area traverse through the predefined unstructured area.

3. The system according to claim 1, wherein the loading machine updates the real-time list each time one of the hauling machines enters the predefined unstructured area and each time one of the hauling machines exits the predefined unstructured area and transmits the updated real-time list to each of the hauling machines currently in the predefined unstructured area.

4. The system according to claim 1, wherein said one hauling machine determines the path by communicating with the hauling machines that are or will be in the predefined unstructured area at the same time as said one hauling machine without the hauling machines transmitting path information to the loading machine and without receiving path information from the loading machine.

5. The system according to claim 1, wherein the path determined by said one hauling machine is such that said one hauling machine will not obstruct any other of the hauling machines that are in the predetermined unstructured area at the same time as said one hauling machine.

6. The system according to claim 1, wherein said one hauling machine updates the path when at the spot location.

7. The system according to claim 1,
wherein said one hauling machine transmits to the loading machine an entry indication upon entering the predetermined unstructured area for the identification of said one hauling machine having entered the predefined unstructured area, the loading machine updating the real-time list based on the entry indication, and/or
wherein said one hauling machine transmits to the loading machine an exit indication upon exiting the predetermined unstructured area with the load material, the loading machine updating the real-time list based on the exit indication.

8. The system according to claim 1,
wherein the loading machine is configured to change the spot location and send updated spot location information to each of the hauling machines that are in the predetermined unstructured area but have yet to arrive at the spot location prior to the change, and
wherein the hauling machines that are in the predetermined unstructured area but have yet to arrive at the spot location prior to the change update their respective paths based on the updated spot location information.

9. A method for collaborative path generation and control for a plurality of mobile machines at a worksite, the worksite having a predefined work area associated with an area controller for the predefined work area, the method comprising:
outputting, using circuitry of the area controller at the worksite, a list of mobile machines currently associated with the predefined work area directly to each of the mobile machines currently associated with the predefined work area based on identification of one of the mobile machines being newly associated with the predefined work area;
outputting, using circuitry of the mobile machines currently associated with the predefined work area, directly to the circuitry of the mobile machine identified to be newly associated with the predefined work area, travel information for the mobile machines currently associated with the predefined work area, the travel information including at least determined travel paths in the predefined work area for the mobile machines currently associated with the predefined work area; and
determining, using circuitry of the mobile machine identified to be newly associated with the predefined work area, a travel path through the predefined work area based on at least the travel information for the mobile machines currently associated with the predefined work area.

10. The method according to claim 9, further comprising controlling, using the circuitry of the mobile machine identified to be newly associated with the predefined work area, the mobile machine identified to be newly associated with the predefined work area to follow the travel path,
wherein said outputting the list of mobile machines is to all of the mobile machines associated with the predefined work area, including said mobile machine identified to be newly associated with the predefined work area, and
wherein the area controller is onboard a work machine at the worksite.

11. The method according to claim 10, wherein said controlling the mobile machine to follow the travel path includes controlling speed and/or timing of the mobile machine along the travel path based on the determined travel paths of at least some of the mobile machines currently associated with the predefined work area.

12. The method according to claim 9, further comprising:
updating, using the circuitry of the area controller, the list of mobile machines currently associated with the predefined work area responsive to exit signaling indicating that one or more of the mobile machines is no longer associated with the predefined work area; and
outputting, using the circuitry of the area controller, the updated list of mobile machines to all mobile machines still associated with the predefined work area.

13. The method according to claim 9, further comprising identifying that the mobile machine in the worksite has reached a predetermined distance away from the predefined work area, said identifying constituting associating the mobile machine with the predefined work area, wherein said identifying includes the mobile machine transmitting to the work machine proximity signaling.

14. The method according to claim 9,
wherein each of the mobile machines is a hauling machine and the work machine is a loading machine,
wherein each of the mobile machines includes a map of the worksite stored in memory, and
wherein said determining the travel path is based on the map stored in the memory of the mobile machine identified to be newly associated with the predefined work area.

15. A non-transitory computer-readable storage medium having stored thereon instructions that, when executed by one or more processors, causes the one or more processors to perform a method comprising:
receiving, at an area controller, a list of mobile machines that are in an unstructured area of a worksite, responsive to identification of a mobile machine entering the unstructured area from a structured area;
receiving, at the area controller, location information including a location at which said mobile machine is to perform a task, when said mobile machine enters the unstructured area; and
coordinating, via the area controller, the mobile machines on the list of mobile machines, for said mobile machine to traverse a locally determined path to the location at which said mobile machine is to perform the task without interfering with locally determined paths of the other mobile machines in the unstructured area.

16. The non-transitory computer-readable storage medium according to claim 15, wherein the unstructured area is defined by a geofence.

17. The non-transitory computer-readable storage medium according to claim 15, wherein the locally determined paths have a speed component and a timing component for each of the mobile machines.

18. The non-transitory computer-readable storage medium according to claim 15, wherein said receiving the list of mobile machines and said receiving the location information is directly from a working machine at the location and without going through a back office system.

19. The non-transitory computer-readable storage medium according to claim 15,
wherein the area controller is onboard said mobile machine or a processor located at the worksite offboard the mobile machines,
wherein each of the mobile machines includes a map of the worksite stored in memory thereof, and
wherein said coordinating is performed based on the map stored in the memories of the mobile machines.

20. The non-transitory computer-readable storage medium according to claim 15, wherein the method further comprises updating the list of mobile machines each time one of the mobile machines is identified to leave the unstructured area and each time one of the mobile machines is identified to enter the unstructured area.
